(19) United States
(12) Patent Application Publication
(10) Pub. No.: US 2025/0190666 A1
(43) Pub. Date: Jun. 12, 2025

(54) INCREMENTAL GLITCH ANALYSIS FOR EFFICIENT GLITCH POWER OPTIMIZATION

(71) Applicant: Synopsys, Inc., Sunnyvale, CA (US)

(72) Inventors: Kailash PAWAR, San Jose, CA (US); Qing SU, Mountain View, CA (US); Prasanna SRINIVAS, Mountain View, CA (US); Rajnish K. PRASAD, Mountain House, CA (US)

(21) Appl. No.: 18/535,934

(22) Filed: Dec. 11, 2023

(51) Int. Cl. G06F 30/337

(52) U.S. Cl. CPC G06F 30/337

(57) ABSTRACT

A system and method for designing integrated circuits with incremental glitch analysis for efficient glitch power optimization, including determining a glitch factor for a combinational logic (CL) gate of a circuit based on arrival time ranges at first and second inputs of the CL gate and an internal delay of the CL gate, updating the glitch factor for the CL gate subsequent to a modification to the circuit design that impacts the CL gate, and determining whether to retain the modification to the circuit design based on the updated glitch factor for the CL gate and an optimization criterion.

### TECHNICAL FIELD

The present disclosure generally relates to an electronic design automation (EDA) system. In particular, the present disclosure relates to incremental glitch analysis for efficient glitch power optimization.

### BACKGROUND

Glitches are spurious pulses that occur at an output of a combinational logic gate before the output settles to a final value or state. Glitches may occur due to differences in arrival times of inputs of the combinational logic gate. Glitches may occur due to re-convergence in a logic cone, where a signal arriving in one branch arrives, or transitions earlier than a signal in another branch. If a width of a glitch pulse is less than an intrinsic delay of the combinational logic gate, the glitch pulse may be absorbed by the combinational logic gate. Wider glitch pulses may propagate and accumulate, leading to glitch hot spots where glitch pulses are more akin to functional transitions. Glitches may not adversely impact the functionality of a circuit, but consumes considerable power. In data path-centric circuits, for example, glitches may account for a portion of total power consumption (e.g., 30% or more of total power consumption). As transistor sizes are scaled down, glitches increasingly become dominant sources of power consumption.

### SUMMARY

A system and method for designing integrated circuits with incremental glitch analysis for efficient glitch power optimization, are disclosed herein. One example is a non-transitory computer readable medium comprising stored instructions, which when executed by a processor, cause the processor to determine a glitch-inducing-window (GIW) for a combinational logic (CL) gate of a circuit design, subsequent to a modification of the circuit design that impacts the CL gate, based on arrival time ranges of first and second inputs of the CL gate, and determine whether to retain the modification of the circuit design based on the first GIW.

Another example is a method that includes determining a glitch factor for a CL gate of a circuit design based on arrival time ranges at first and second inputs of the CL gate and internal delays of the CL gate, performing an incremental modification to the circuit design, where the first incremental modification impacts the CL gate, updating the glitch factor for the CL gate subsequent to the incremental modification, and determining whether to retain the incremental modification to the circuit design based on the updated glitch factor for the CL gate and an optimization criterion.

Another example is a system that include a memory that stores instructions and a processor, coupled with the memory and to execute the instructions, the instructions when executed cause the processor to determine a glitch factor for a CL gate of a circuit based on arrival time ranges at first and second inputs of the CL gate and internal delays of the CL gate, update the glitch factor for the CL gate subsequent to a modification to the circuit design that impacts the CL gate, and determine whether to retain the modification to the circuit design based on the updated glitch factor for the CL gate and an optimization criterion.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram of a computing platform, according to an embodiment.

FIG. 2 is a logic diagram of a circuit design, according to an embodiment.

FIG. 3A is a logic diagram of network of combination logic (CL) gates, according to an embodiment.

FIG. 3B illustrates a timing diagram for the CL gate of FIG. 3A, according to an embodiment.

FIG. 3C illustrates another timing diagram for the CL gate of FIG. 3A, according to an embodiment.

FIG. 4A is an illustration of glitch-inducing window (GIW) for the CL gate of FIG. 3A, according to an embodiment.

FIG. 4B is an illustration of another GIW for the CL gate of FIG. 3A, according to an embodiment.

FIG. 4C is an illustration of another GIW for the CL gate of FIG. 3A, according to an embodiment.

FIG. 5A illustrates timing diagrams corresponding to points of the GIW of FIG. 4A, according to an embodiment.

FIG. 5B illustrates a subset of the timing diagrams of FIG. 5A, according to an embodiment.

FIG. 6 is an illustration of another network of CL gates, according to an embodiment.

FIG. 7 illustrates a method of incremental glitch analysis, according to an embodiment.

FIG. 8 illustrates another method of incremental glitch analysis, according to an embodiment.

FIG. 9 depicts a flowchart of various processes used during the design and manufacture of an integrated circuit in accordance with some embodiments of the present disclosure.

FIG. 10 depicts a diagram of an example emulation system in accordance with some embodiments of the present disclosure.

FIG. 11 depicts a diagram of an example computer system in which embodiments of the present disclosure may operate.

### DETAILED DESCRIPTION

Aspects of the present disclosure relate to incremental glitch analysis for efficient glitch power optimization.

A circuit design (e.g., a gate-level netlist) may be optimized (i.e., modified/altered) for desired characteristics such as performance (e.g., timing/frequency), power consumption (e.g., leakage or dynamic power), and/or area (e.g., physical area and/or lines of code), collectively referred to PPA. Optimization may include re-routing tracks (i.e., signal, power, and/or clock tracks), re-sizing transistors, inserting delay elements, and/or other alterations. Optimization may include balancing competing desired characteristics.

Power consumption optimization may be directed to power consumption of functional components and interconnections. Since glitch activity accounts for a significant portion of overall power consumption in an integrated circuit, it would be useful to account for glitch activity/glitch power consumption as well when optimizing a circuit design.

Glitch activity in a circuit design is a secondary effect of arrival-propagation (i.e., times at which data signals transitions at inputs to a logic gate). When a circuit design is modified, the modification may change arrival-propagation, which may change (i.e., increase or decrease) glitch activity. A change in arrival-propagation may arise due to modifications within a fanin cone of a logic gate and/or from modifications in a side-path of the logic gate. A change in arrival-propagation may appear in a fanout cone of a modification. Tracking such dynamic changes in glitch activity is challenging in that it may be difficult to determine a source of a change in glitch activity, and/or it may be difficult to determine where the change in glitch activity may propagate within a fanout cone of the source. In addition, signals may arrive at inputs to a logic gate later than anticipated (i.e., late arrivals) for one or more of a variety of reasons, which further complicates analysis of glitch activity in a circuit design.

Glitch activity may be detected by simulating, emulating, and/or prototyping (collectively referred to as simulating) operation of a circuit design. Simulation of a circuit design is, however, computationally expensive and time consuming. Depending on the size/complexity of the circuit design and simulation length, a single simulation cycle may take hours to complete, and would need to be repeated as changes are made to the circuit design. Simulation-based glitch analysis during optimization is thus prohibitively expensive.

Incremental glitch analysis techniques disclosed herein include a system and method to model glitch activity (e.g., glitch-inducing windows (GIWs)), and to quantify glitch activity (e.g., glitch factors (GFs)), and to track changes in glitch activity based on incremental modifications of a circuit design. GIWs model the interaction of data signals at inputs of combinational logic (CL) gates. GIWs are based on maximum (late-arrival) and minimum (glitch-arrival) times at which the data signals may arrive at the inputs of CL gates. GFs quantify the glitch activity modeled by the GIWs. An incremental optimization may result in a change in the GFs of a CL gate. The change in the GF indicates whether the optimization resulted in increased or decreased glitch activity at the CL gate.

The present incremental glitch analysis system and method disclosed herein tracks incremental modifications to a circuit design (e.g., a netlist), and corresponding changes in operating parameters of the circuit design (e.g., a timing parameter, such as slew, capacitance, delays, arrival). Based on changes in the operating parameters, CL gates impacted by the modifications are scheduled for incremental glitch analysis.

The present incremental glitch analysis system and method disclosed herein are relatively fast and efficient, and may be performed throughout an electronic design automation (EDA) optimization process. Incremental glitch analysis may be integrated as part of an EDA optimization process, such as performance (e.g., timing) optimization and/or power optimization. Such integration may be useful to permit the EDA optimization process(es) to consider glitch impacts during optimization (e.g., as an optimization criterion). Incremental glitch analysis may be performed as part of an inner-loop of an EDA optimization process, where incremental glitch analysis it may be exercised numerous (e.g., millions) of times over the course of incremental modifications to a circuit design. Incremental glitch analysis may be useful to ensure that timing-based optimizations and/or power-based optimizations do not adversely impact glitch activity. For example, a timing optimization engine may use incremental glitch analysis results as one of multiple cost considerations.

Technical advantages of the present disclosure include, but not limited to, reduction in computing resources. As examples, and without limitation, analyzing glitch activity of circuit components that are likely to be impacted by modifications to a circuit design, and doing so incrementally (i.e., following each of multiple modification), uses considerably less/fewer computing resources relative to analyzing glitch activity of the entire circuit design after each modification (e.g., less/fewer memory resources are needed to store results of incremental analyses relative to a full circuit simulation approach). Analyzing glitch activity based on known delay ranges of circuit components also uses fewer/less computing resources than analyzing glitch activity based on simulated operation of a circuit design. The time savings makes is feasible to analyze glitch activity during EDA.

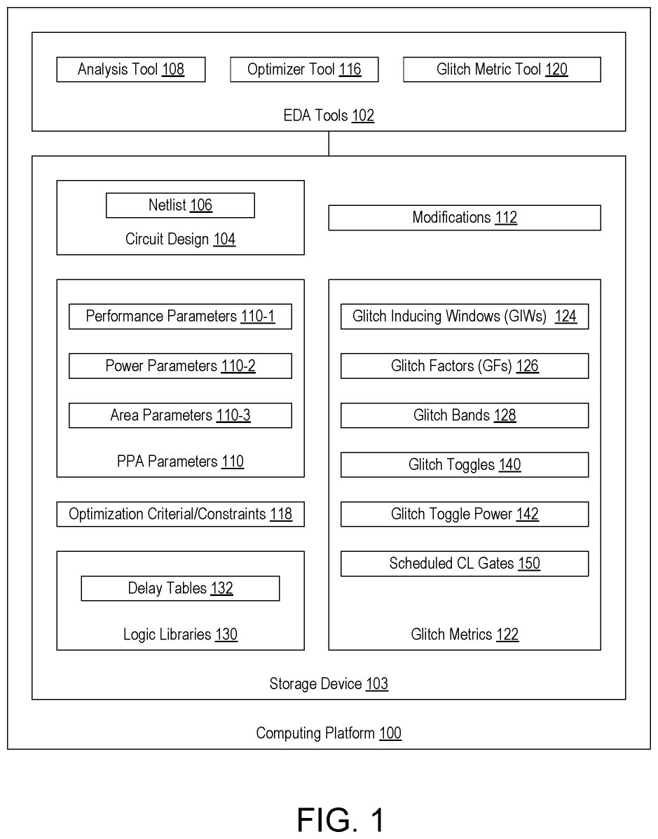

FIG. 1 is a block diagram of a computing platform 100, according to an embodiment. Computing platform 100 may include, without limitation, a processor and memory encoded with one or more computer programs, and/or other circuitry. Computing platform 100 may represent multiple computing platforms, which may be centralized or distributed.

Computing platform 100 includes a suite of electronic design automation (EDA) tools 102 that analyze and optimize a circuit design 104. Computing platform 100 further includes a storage device 103.

In FIG. 1, EDA tools 102 include an analysis tool 108 that analyzes circuit design 104. Analysis tool 108 may determine or compute PPA parameters 110, or a subset thereof, of circuit design 104. PPA parameters 110 may include, for example and without limitation, performance (e.g., timing/frequency) parameters 110-1, power parameters 110-2, area parameters 110-3, which may be collectively referred to as PPA parameters 110. Analysis tool 108 also determines glitch toggles 140, which are described further below. Analysis tool 108 may represent multiple analysis tools, which may include, without limitation, a timing analysis tool, a power analysis tool, an area analysis tool, a toggle activity detection tool, and/or other analysis tool(s).

EDA tools 102 further include an optimizer tool 116 that optimizes circuit design 104 based on optimization criteria 118. Optimization criteria 118 may include criteria related to performance, power, area (PPA), toggle/glitch activity, and/or other factors. Optimizer tool 116 may optimize circuit design 104 to improve performance parameters 110-1, power parameters 110-2, area parameters 110-3, glitch toggles 140, and/or other parameters. Optimizer tool 116 may represent multiple optimization tools, which may include, without limitation, a timing optimizer tool, a power optimizer tool, a glitch power optimizer tool, and/or other optimizer tool(s).

An optimizer tool may be integrated with a corresponding analysis tool. An integrated tool may, target one or more of a variety of types of power consumption/loss (e.g., leakage, dynamic, glitch) in tandem with power analysis (e.g., measuring power-related impacts of circuit design modifications). Alternatively, or additionally, an integrated tool may target delay-based-optimizations (e.g., optimizations directed to improving performance of a circuit design) in tandem with timing analysis (e.g., measuring timing-related impacts of circuit design modifications).

EDA tools 102 further include a glitch metric tool 120 that computes glitch metrics 122. Glitch metric tool 120 and glitch metrics 122 are described further below.

Circuit design 104 may include a netlist 106 that contains a description of circuit elements and connectivity of circuit design 104. Netlist 106 may include a list of electronic components of circuit design 104, and a list of nodes to which the electronic components are connected.

Circuit design 104 may include a sequential circuit. A sequential circuit is a circuit that includes sequential logic gates interspersed with networks of combinational logic (CL) gates (referred to herein as CL networks). A sequential logic gate is a logic gate for which an output is based at least in part on a prior state of an input to the logic gate. Example sequential logic gates include flip-flops, latches, registers, and random access memory (RAM). A sequential logic gate registers input data and asserts an output based on a clock. Proper operation of a sequential logic gate requires that the input data remain steady for a certain amount of time (setup time) prior to a clock event, and for a certain amount after the clock event (hold time). A CL gate is a logic gate for which an output is a function of a current state of an input(s) to the logic gate. A CL gate generally lacks memory and internal state. Example CL gates include AND, OR, XOR, and/or inverter logic gates.

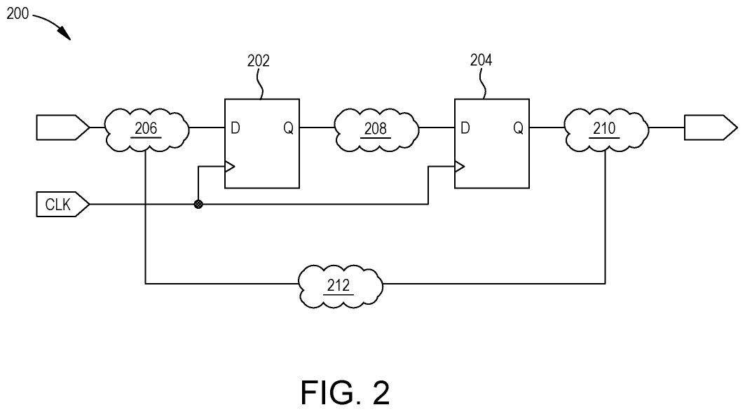

FIG. 2 is a logic diagram of a circuit design, according to an embodiment. In the example of FIG. 2, circuit design 200 includes sequential logic gates 202 and 204, illustrated here as flip-flops (FFs). Circuit design 104 further includes CL networks 206, 208, 210, and 212.

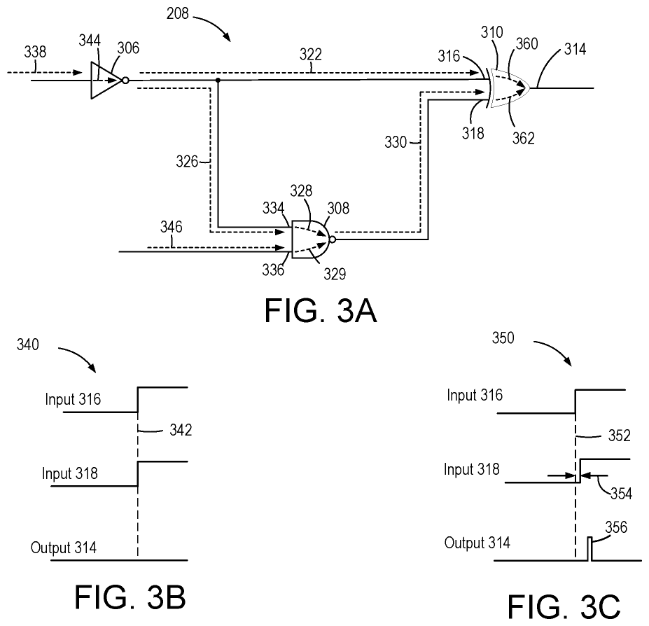

FIG. 3A is a logic diagram of CL network 208, according to an embodiment. In the example of FIG. 3A, CL network 208 includes a CL inverter gate 306, a CL NAND gate 308, and a CL XOR gate 310. CL XOR gate 310 includes multiple data inputs, illustrated here as inputs 316 and 318, and an output 314. Glitches may occur at output 314 when data inputs 316 and 318 do not transition in unison, such as described below with reference to FIGS. 3B and 3C.

FIG. 3B illustrates a timing diagram 340 for CL XOR gate 310, according to an embodiment. In FIG. 3B, data inputs 316 and 318 of CL XOR gate 310 simultaneously toggle, or change state, from logic state 0 to logic state 1, at time 342. In other words, there is little or no difference in arrival times of data inputs 316 and 318. In this example, output 314 of CL XOR gate 310 remains at logic state 0 prior to time 342, and subsequent to time 342 (i.e., without glitches).

FIG. 3C illustrates a timing diagram 350 for CL XOR gate 310, according to an embodiment. In FIG. 3C, data input 318 of CL XOR gate 310 toggles, or changes state, from logic state 0 to logic state 1 slightly after a time 352 at which data input 316 changes state. In other words, there is a difference 354 in arrival times of data inputs 316 and 318. The difference 354 in arrival times results in a glitch 356. A duration of glitch 356 corresponds to the difference 354 in arrival times.

Arrival times of inputs data inputs 316 and 318 may differ from one another for a variety of reasons, including differences in delays leading to data inputs 316 and 318. In the example of FIG. 3A, arrival times of data input 316 depend in part on a delay 338 leading up to CL inverter gate 306, an internal delay 344 of CL inverter gate 306 (e.g., a gate or switching delay), and an interconnect delay 322 of an interconnect between an output of CL inverter gate 310 and data input 316. Arrival times of data input 318 depend in part on a delay 346 leading up to an input 336 of CL NAND gate 308, an interconnect delay 326 between the output of CL inverter gate 310 and an input 334 of CL NAND gate 308, internal delays 328 and 329 of CL NAND gate 308, and an interconnect delay 330 between an output of CL NAND gate 308 and data input 318. Internal delays 360 and 362 of CL XOR gate are discussed further below.

Interconnect delays and internal delays may depend on variable factors with may include, without limitation, process corners, driver-strength, load capacitance, input slew, output load, and/or environmental factors such as coupling between nets and/or process, voltage, and/or temperature (PVT) variations. It may thus be difficult to precisely compute arrival times based on a circuit design. Instead, analysis tool 108 (and/or one or more other ones of EDA tools 102) may determine arrival times as arrival time ranges. Analysis tool 108 may determine (e.g., compute) arrival time ranges based, in whole or in part, based on variable factors, such as described above. In an example, analysis tool 108 computes arrival time ranges based on a structure of a netlist and internal delays of CL gates and interconnect delays between the CL gates, which may be retrieved and/or derived from one or more data sources. As an example, analysis tool 108 may determine internal delays of CL gates based on one or more specified characteristics of a library cell-specific characteristic.

In the example of FIG. 3A, analysis tool 108 may determine an arrival time range of data input 318 of CL XOR gate 310 based on minimum and maximum arrival times of data input 318. Optimizer tool 116 may determine the minimum and maximum arrival times of data input 318 based on respective minimum and maximum values of delays 338, 344, 326, 346, 328, 329, and 330, such as described further above. Analysis tool 108 may determine the minimum and maximum arrival times of data input 318 by accumulating the minimum and maximum values of delays 338, 344, 326, 346, 328, 329, and 330. Accumulating the minimum and maximum delays may account for cumulative impacts of minimum and maximum values of delays 338, 344, 326, 346, 328, 329, and 330. Analysis tool 108 may determine an arrival time range of data input 316 of CL XOR gate 310 based on minimum and maximum values of delays 338, 344, and 332, in a similar fashion.

In an embodiment, glitch metric tool 120 in FIG. 1 defines a glitch-inducing window (GIW) 124 based on arrival time ranges for inputs 316 and 318. Glitch metric tool 120 may define a GIW 124 based on minimum and maximum possible/potential values of the delays 338, 344, 322, 326, 346, 328, 329, and 330. In other words, a GIW 124 represents a time zone in which a signal arriving at an input of a CL gate is skewed due to a structure of netlist 106. Switching signal skew is a determinant of glitch induction and reduction.

Analysis tool 108 may determine arrival time ranges (also referred to herein as propagating arrivals or propagating late arrivals) based on netlist 106. Depending on the level of detail of netlist 106, analysis tool 108 may retrieve detailed delay information and/or may use pre-determined generalized delay information. For example, where netlist 106 is a technology-mapped netlist of gate-level components (i.e., technology-specific logic gates), analysis tool 108 may retrieve gate-level delay information from logic libraries 130 in FIG. 1 (e.g., cell libraries). Where circuit design 104 includes a higher-level non-technology mapped netlist (e.g., a netlist of primitive logic gates, such as AND, OR, XOR, inverter and/or other types of logic gates), analysis tool 108 may use predetermined delay values for the respective types, or may use a predetermined 1-gate delay value.

Analysis tool 108 may retrieve delay information from delay tables 132 of logic libraries 130. Delay tables 132 may list delays as a function of one or more variables, such as input transition time, output load capacitance, logic type, temperature processing, and/or other factors. Analysis tool 108 may compute internal delays based on the table entries. Alternatively, or additionally, analysis tool 108 may retrieve internal delay information and/or interconnect delay information from a file(s), which may be formatted in accordance with a standard delay format (SDF) promulgated by the Institute for Electrical and Electronics Engineers (IEEE). The SDF represents and interprets timing data for use at various stages of EDA processes. An SDF file may include internal delays, timing constraint values, interconnect/net delays, and/or technology parameters. An SDF file may include separate sections for internal delays and interconnect delays.

Glitch metric tool 120 may define (e.g., compute or construct) GIWs 124 for CL gates of circuit design 104 (e.g., for scheduled CL gates 150) based on a structure of netlist 106. Glitch metric tool 120 may define GIWs 124 independent of timing constraints of circuit design 104. Where analysis tool 108 computes interconnect delays and/or internal delays for timing-analysis, glitch metric tool 120 may leverage the computed interconnect delays and/or internal delays for determining arrival time ranges (i.e., for propagating glitch arrivals) for glitch analysis.

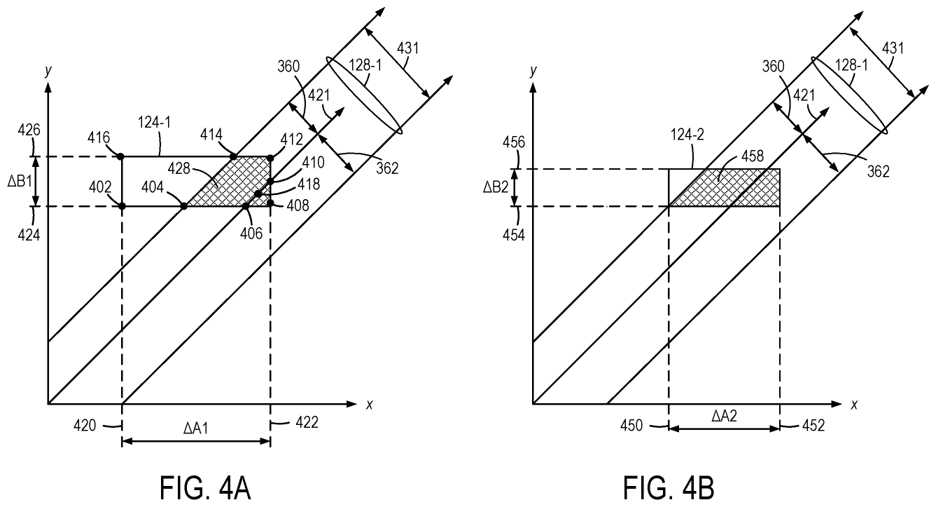

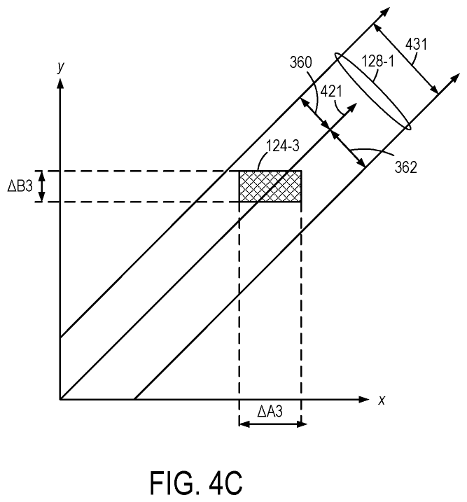

FIG. 4A is an illustration of a GIW 124-1 for CL XOR gate 310, according to an embodiment. FIG. 4B is an illustration of another GIW 124-2 for CL XOR gate 310, according to an embodiment. FIG. 4C is an illustration of another GIW 124-3 for CL XOR gate 310, according to an embodiment.

In the example of FIG. 4A, GIW 124-1 is illustrated as a rectangle having a width ΔA1 and a height ΔB1. ΔA1 represents the arrival time range for input 316 which analysis tool 108 may determine based on minimum and maximum values of delays 338, 344, 326, 346, 328, 329, and 330, such as described further above. ΔA1 represents a difference between a minimum arrival time 420 and a maximum arrival time 422 of input 316. ΔB1 represents an arrival time range for input 318. Analysis tool 108 may determine ΔB1 based on minimum and maximum values of delays 338, 344, and 332, such as described further above. For a CL gate that includes more than two inputs, glitch metric tool 120 may select a first input for which a lower end of the arrival time range is lowest, a second input for which an upper end of the latest arrival time range is highest, and may compute a GIW 124 for the CL gate based on the lower end of the arrival time range of the first input and the upper end of the arrival time window of the second input.

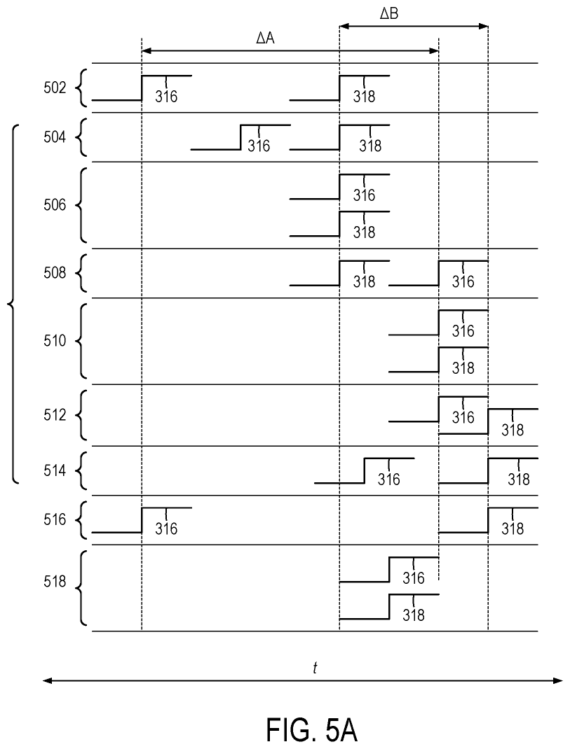

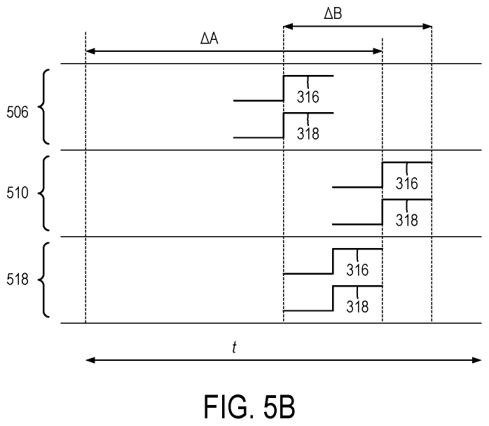

Glitch metric tool 120 may determine a glitch band 128-1 for CL XOR gate 310. A width 431 of glitch band 410 represents internal delays 360 and 362 of CL XOR gate 310, which may be determined as described further above. Differences in arrival times of inputs 316 and 318 that are within glitch band 128-1 are absorbed by CL XOR gate 310. In other words, when skew between signals arriving at inputs 316 and 318 is sufficiently small, or zero, there is no glitch at output 314 of CL XOR gate 310. A line 421 (i.e., y=x) represents zero difference in arrival times of inputs 316 and 318 (i.e., ideal behavior in which signals at inputs 316 and 318 are synchronous with one another). A position of GIW 124-1 relative to glitch band 128-1 indicates how well CL XOR gate 310 will absorb glitches in view of the arrival time ranges of data inputs 316 and 318. Examples are provided below with reference to FIGS. 4A, 4B, 4C, 5A, and 5B.

FIG. 5A illustrates timing diagrams 502 through 518, corresponding to points 402 through 418 respectively of GIW 124-1, according to an embodiment. Timing diagram 502 corresponds to point 402 in which input 316 transitions at minimum arrival time 420, and input 318 transitions at minimum arrival time 424. Timing diagram 512 corresponds to point 412 in which input 316 transitions at maximum arrival time 422, and input 318 transitions at maximum arrival time 426. Similarly, other timing diagrams 504, 506, 508, 510, 514, 516, and 518 illustrate the transitions of inputs 316 and 318 at points 404, 406, 408, 410, 414, 416, and 418 respectively.

FIG. 5B illustrates timing diagrams 506, 510, and 518, corresponding to points 406, 410, and 418 respectively along line 421 of GIW 124-1, according to an embodiment. Timing diagrams 506, 510, and 518 correspond to ideal behavior in which arrival times of data inputs 316 and 316 are synchronous with one another.

In FIG. 4A, width ΔA1 and/or height ΔB1 may change following a modification of circuit design 104 that impacts CL XOR gate 310. Such a modification may include, for example and without limitation, reducing a length of the interconnect between the output of CL inverter gate 306 and input 334 of CL NAND gate 308, replacing CL NAND gate 308 with a CL NAND gate having more drive power than CL NAND gate 308, and/or other modification. GIW 124-1 in FIG. 4A may represent CL XOR gate 310 prior to modification, and GIW 124-2 in FIG. 4B and GIW 124-2 in FIG. 4C may represent CL XOR gate 310 following respective incremental modifications of circuit design 104. In FIG. 4B, GIW 124-2 width ΔA2 is less than width ΔA1 of GIW 124-1, and height ΔB2 is less than height ΔB1 of GIW 124-1. The example of FIG. 4B thus represents a situation in which the modification reduces the arrival time ranges at data inputs 316 and 318 (i.e., reduced ΔA and ΔB). In FIG. 4A, a shaded region 428 of GIW 124-1 is within glitch band 128-1. A remaining (i.e., unshaded) region of GIW 124-1 is outside glitch band 128-1. In FIG. 4B, a greater percentage of GIW 124-2 (i.e., a shaded region 458 in FIG. 4B) is within glitch band 128-1, relative to shaded region 428 of GIW 124-1.

A percentage of an area of a GIW 124 that lies within glitch band 128-1, represents a likelihood that glitches will be absorbed by the corresponding CL gate. In FIG. 4A, a percentage of an area of GIW 124-1 that lies within glitch band 128-1 (i.e., shaded region 428), represents a likelihood that glitches will be absorbed by CL XOR gate 310. In FIG. 4B, a percentage of an area of GIW 124-2 that lies within shaded region 458, represents a likelihood that glitches will be absorbed by CL XOR gate 310. Increasing the percentage of an area of a GIW 124 that lies within glitch band 128-1 (i.e., as in FIG. 4B), increases the likelihood that glitches will be absorbed by the CL XOR gate 310. In other words, the example of FIG. 4B indicates that the modification resulted in a higher percentage of glitch absorption relative to the example of FIG. 4A. In FIG. 4C, GIW 124-3 width ΔA3 is less than width ΔA2 of GIW 124-2, and height ΔB3 is less than height ΔB2 of GIW 124-2. Further in FIG. 4C, the entirety of GIW 124-3 is within glitch band 128-1. The example of FIG. 4C thus represents further improvement in glitch absorption (i.e., complete glitch absorption).

During incremental updates, glitch metric tool 120 computes glitch factors (GFs) 126 based on GIWs 124-1, 124-2, and 124-3. A GF 126 serves as a relative metric of toggle/glitch activity for a CL gate of a design-instance (i.e., a current state of circuit design 104/netlist 106), indicating glitches that can be absorbed. In an embodiment, during incremental updates, glitch metric tool 120 computes GFs 126 based on overlapping regions of corresponding glitch bands 128-1 to determine whether a modification of circuit design 104 improves glitch absorption.

In FIG. 4A, glitch metric tool 120 may compute a GF 126 for CL XOR gate 310 based on an area of shaded region 428 of GIW 124-1. In an embodiment, glitch metric tool 120, computes GF 126 for CL XOR gate 310 as a ratio of the area of shaded region 428 to a total area of GIW 124-1:

GF=Area of Shaded Region 428/Area of GIW 124-1

The metric GF 126 indicates the ratio of glitch being eliminated to the induced glitch, which is indicated by area of GIW 124-1. Therefore, eliminated glitch is estimated as a GF ratio of the induced glitch, that is, eliminated glitch=induced glitch*GF. Hence, the final net glitch on any instance=Induced Glitch-Eliminated Glitch=Induced Glitch-Induced Glitch*GF.

During incremental updates, an amount of reduction in GF represents eliminated glitch activity of the corresponding CL gate. During incremental glitch-analysis, EDA tools 102, or a subset thereof, may track changes in GIWs 124 and/or changes in GFs 126 to systematically guide optimization (e.g., to reduce the area of GIWs 124, to move the GIWs into glitch band 128-1, and/or to increase width 431 of glitch band 128-1). For example, optimizer tool 116 may use GIWs 124 and/or GFs 126 as a cost function (e.g., to make decisions regarding modifications to circuit design 104 to suppress glitches or alter glitches to reduce impacts of the glitches on total power consumption).

In an embodiment, EDA tools 102, or a subset thereof, (e.g., optimizer tool 116) tracks modifications made to circuit design 104 (e.g., changes made to netlist 106) as modifications 112, and correlates modifications 112 to GFs 126 and/or to changes in GFs 126. Optimizer tool 116 may treat changes in GFs 126s of CL gates as optimization criteria 118. Where a netlist includes a library cell for a CL gate, the library cell may be replaced with another library cell to increase the width of glitch band 128-1, which effectively increases glitch elimination.

During incremental optimization, the width of glitch band 128-1 may be increased by modifying a characteristic of CL XOR gate 310 (e.g., by using a difference library cell for CL XOR gate 310). Increasing the width of glitch band 128-1 may be useful to increase the GF (i.e., effectively increasing the extent to which CL XOR gate 310 absorbs glitches).

GIWs 124, GFs 126, and glitch bands 128 are characteristics of design-instances. In other words, circuit design 104 may include multiple instances of a particular logic gate. In such a situation, GIWs 124, GFs 126, and glitch bands 128 may vary amongst the instances of the logic gate based on factors associated with the respective instances (e.g., layout location, connectivity, process, voltage, temperature, and/or factors).

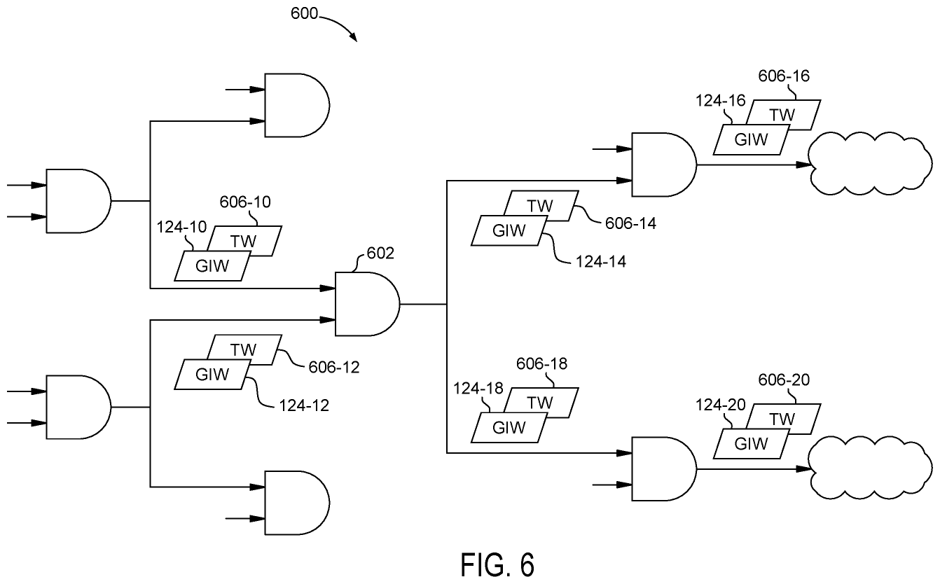

FIG. 6 is an illustration of a CL network 600 of a circuit design, according to an embodiment. FIG. 6 includes timing windows 606-10 and 606-12 (e.g., set-up and hold times for sequential logic gates) for performance/timing optimization, and GIWs 124-14 through 124-20 for incremental glitch analysis. In an embodiment, EDA tools 102, or a subset thereof, simultaneously tracks changes in the GIWs and changes in the timing windows. In the example of FIG. 6, EDA tools 102, or a subset thereof, may optimize/modify circuit CL network 600 based on GIWs 124-10 and 124-12 and timing windows 606-10 and 606-12 at inputs of a CL gate 602, and may track resultant changes in GIWs 124-10 and 124-12 and timing windows 606-10 and 606-12. EDA tools 102, or a subset thereof, may also track changes in GIWs and timing windows within a fanout cone of CL gate 602 (e.g., GIWs 124-14 through 124-20 and timing windows 606-14 through 606-20). FIG. 6 illustrates that incremental glitch-updates may be coupled (i.e., may impact) to timing-updates. Since a glitch is a second order effect of change in arrival, it is possible that arrival times may not change at the inputs of CL gate 602, yet glitch activity may propagate from CL gate 602.

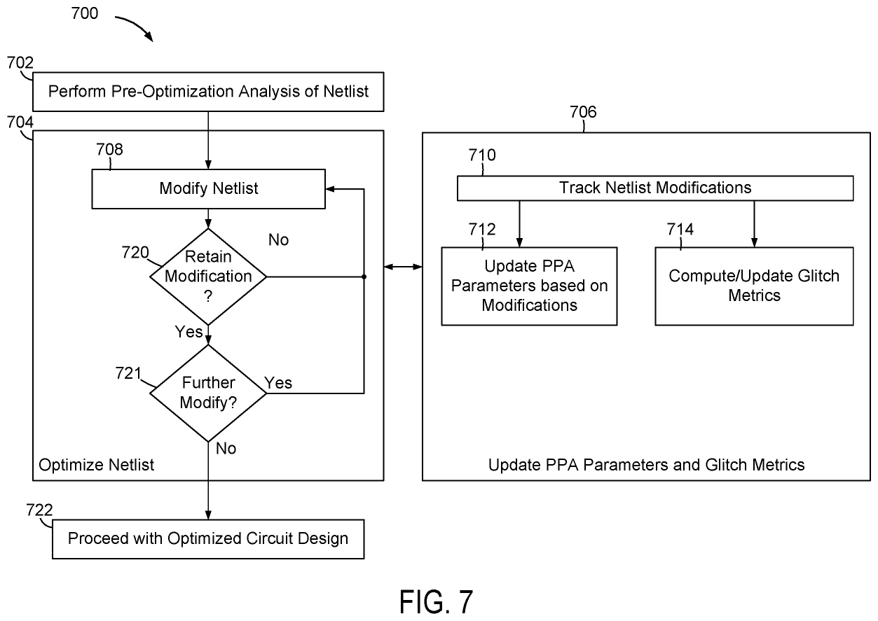

FIGS. 1 through 6 are described below with reference to FIG. 7. FIG. 7 illustrates a method 700 of incremental glitch analysis, according to an embodiment. Method 700 is described below with reference to FIGS. 1 through 6. Method 700 is not, however, limited to the examples of FIGS. 1 through 6.

At 702, analysis tool 108 performs a pre-optimization analysis of circuit design 104 to determine initial values for PPA parameters 110 and glitch metrics 122, or a subset thereof. In an embodiment, analysis tool 108 determines initial values for at least power parameters 110-2 and one or more glitch metrics 122. Analysis tool 108 may also determine initial values for performance parameters 110-1 (e.g., timing/frequency parameters) and/or area parameters 110-3, if circuit design 104 is to be optimized for performance and/or area as well power.

In an embodiment, during pre-optimization analysis, analysis tool 108 determines initial values for glitch toggles 140 and/or glitch toggle power 142. Glitch toggles 140 represent unintended toggle activity (i.e., glitches). Glitch toggle power 142 represents power consumed due to glitch toggles 140. Analysis tool 108 may determine initial values for glitch toggles 140 based on one or more of a variety of methods such as, for example and without limitation, simulated operation of circuit design 104, an estimation method based on GIWs, and/or a delay-shifted Monte Carlo method. Analysis tool 108 may determine initial values for glitch toggle power 142 based on dynamic power resulting from glitch toggles 140. Analysis tool 108 may monitor glitch toggles at outputs of CL nets and/or within fanin and/or fanout cones of CL gates. Analysis tool 108 may identify regions of circuit design 104 and/or CL gates of circuit design 104 that have relatively high levels (e.g., frequency) of glitch toggles 140 (i.e., glitch hotspots) and/or to identify sources of such glitch hotspots.

During pre-optimization analysis, or upon conclusion of pre-optimization analysis, analysis tool 108 or glitch metric tool 120 may identify or select CL gates of circuit design 104 (i.e., scheduled CL gates 150) for tracking and analysis during incremental optimization, based on the initial values for glitch toggles 140 and/or glitch toggle power 142. Glitch metric tool 120 may compute GIWs 124, GFs 126, and/or glitch bands 128 for scheduled CL gates 150.

Pre-optimization analysis at 702 may be relatively comprehensive/exhaustive, and thus time consuming (e.g., relative to what may be acceptable/tolerable during optimization). Analysis tool 108 may determine initial values for PPA parameters 110 and glitch metrics 122, or a subset thereof, by analyzing the entirety of circuit design 104. Analysis tool 108 may determine the initial values for PPA parameters 110 and glitch metrics 122 by simulating, emulating, and/or prototyping circuit design 104 (e.g., based on netlist 106), and/or by computing the initial values based on netlist 106.

After the pre-optimization analysis at 702, optimizer tool 116 incrementally optimizes circuit design 104 at 704, as analysis tool 108 and glitch metric tool 120 track modifications 112 to circuit design 104 and update PPA parameters 110 and glitch metrics 122, at 706, as described below.

At 708, optimizer tool 116 modifies circuit design 104 (e.g., netlist 106) to improve the initial values of PPA parameters 110 and/or glitch metrics 122. Optimizer tool 116 may, for example and without limitation, re-route tracks (i.e., signal, power, and/or clock tracks), re-size gates/transistors, insert delay elements, and/or perform other modifications. Optimization may include balancing competing optimization criteria 118.

At 710, EDA tools 102, or a subset thereof, track the modifications of circuit design 104 from 708 as modifications 112.

At 712, analysis tool 108 updates PPA parameters 110 (or a subset thereof).

Analysis tool 108 may perform an incremental or partial analysis of circuit design 104, in view of modifications 112. Analysis tool 108 may, for example, analyze portions of circuit design 104 (e.g., portions of netlist 106) impacted by recent modifications 112. Analysis tool 108 may update PPA parameters 110 by simulating, emulating, and/or prototyping the portions of circuit design 104, and/or by computing updated values based on recent modifications 112. Analysis tool 108 may simulate, emulate, and/or prototype the portions of circuit design 104 relatively fast (i.e., significantly faster than it would take to simulate, emulate, and/or prototype the entirety of circuit design 104).

At 714, glitch metric tool 120 updates glitch metrics 122 for scheduled CL gates 150. In an example, analysis tool 108 re-compute differences in arrival times and/or late arrival time ranges for scheduled CL gates 150, and glitch metric tool 120 re-computes glitch metrics 122 based on the re-compute differences in arrival times and/or late arrival time ranges. Thus, for glitch-optimization, EDA tools 102 may dynamically monitor changes in glitch metrics 122 of scheduled CL gates 150 (and CL gates within fanin and/or fanout codes of scheduled CL gates 150), as scheduled CL gates 150 are modified (and/or as CL gates within fanin and/or fanout codes of the scheduled CL gates 150 are modified), and may continue to optimize/modify scheduled CL gates 150 in view of the dynamic changes in glitch metrics 122.

Glitch metric tool 120 may also dynamically update scheduled CL gates 150 based on modifications 112 (e.g., to include CL gates likely or potentially impacted by modifications 112, and/or include GL gates within fanin and/or fanout cones of CL gates likely or potentially impacted by modifications 112).

At 720, analysis tool 108 determines whether to retain the modification from 708 based on updated PPA parameters 110 and glitch metrics 122 from 706, and optimization criteria 118. Analysis tool 108 may determine to retain the modification from 708 if updated glitch metrics of 714 are an improvement over prior glitch metrics and/or if updated PPA parameters 110 and/or glitch metrics 122 satisfy optimization criteria 118.

If analysis tool 108 determines to retain the modification from 708, processing proceeds to 721, where analysis tool 108 determines whether to continue modifying circuit design 104. If analysis tool 108 determines to continue modifying circuit design 104, processing returns to 708c for a subsequent round of optimization with incremental glitch analysis. Optimization with incremental glitch analysis (i.e., 704 and 706) may be repeated until analysis tool 108 determines to halt modifying circuit design 104. When analysis tool 108 determines to halt modifying circuit design 104 at 722, circuit design 104 is passed to a subsequent design phase and/or fabrication stage at 724.

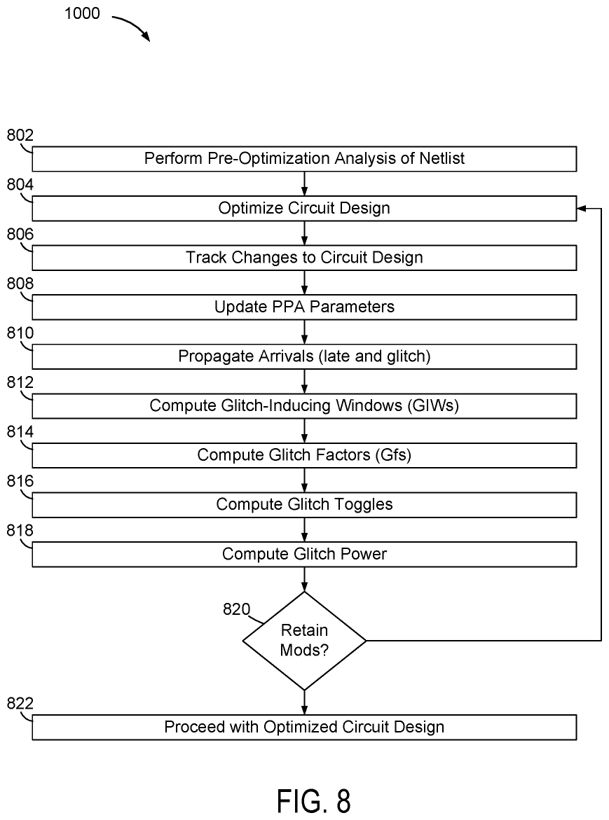

FIG. 8 illustrates a method 800 of incremental glitch analysis, according to an embodiment. Method 800 is described below with reference to FIGS. 1 through 6. Method 800 is not, however, limited to the examples of FIGS. 1 through 6.

At 802, analysis tool 108 performs a pre-optimization analysis of circuit design 104, such as described above with reference to 702 in FIG. 7.

At 804, optimizer tool 116 modifies circuit design 104 (e.g., netlist 106), such as described above with reference to 708 in FIG. 7.

At 806, EDA tools 102, or a subset thereof, tracks modifications 112 to circuit design 104, such as described above with reference to 710 in FIG. 7.

At 808, analysis tool 108 updates performance parameters 110-1 and power parameters 110-2, based on modifications 112, such as described above with reference to 712 in FIG. 7. Analysis tool 108 may also update area parameters 110-3.

At 810, glitch metric tool 120 propagates arrivals (i.e., late and glitch) to determine differences in arrival times of inputs to CL gates of circuit design 104, such as described above with reference to 714 in FIG. 7.

At 812, glitch metric tool 120 defines GIWs 124 for CL gates (e.g., for scheduled CL gates 150) of circuit design 104, such as described above with reference to 714 in FIG. 7.

At 814, glitch metric tool 120 computes GFs 126 for CL gates (e.g., for scheduled CL gates 150) of circuit design 104, such as described above with reference to 714 in FIG. 7.

At 816, glitch metric tool 120 computes and updates glitch toggles 140 using GFs for CL gates (e.g., for scheduled CL gates 150) of circuit design 104, such as described above with reference to 714 in FIG. 7.

At 818, glitch metric tool 120 computes glitch toggle power 142 for CL gates (e.g., for scheduled CL gates 150) of circuit design 104, such as described above with reference to 714 in FIG. 7.

At 820, analysis tool 108 determines whether to retain the modifications from 804 based on the updated PPA parameters of 808, the GIWs from 812, the GFs from 814, the glitch toggles from 816, the glitch power from 818, and optimization criteria 118. If analysis tool 108 determines to retain the modifications from 804, circuit design 104 is passed to a subsequent design phase and/or fabrication stage at 822. If analysis tool 108 determines to discard the modifications from 804, processing returns to 704 for a subsequent round of optimization with incremental glitch analysis.

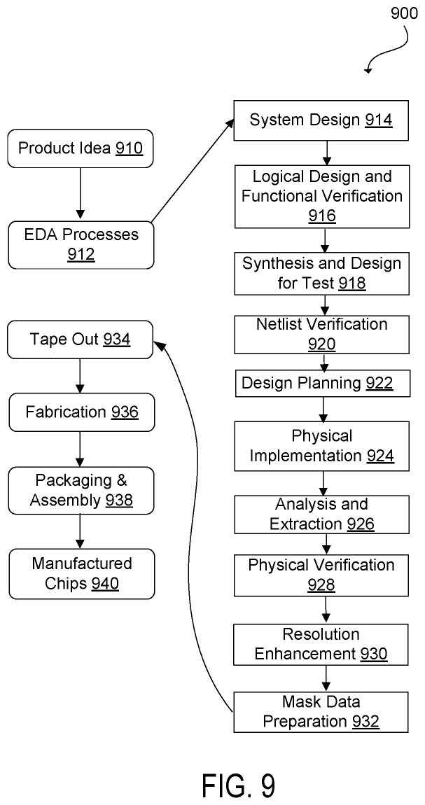

FIG. 9 illustrates an example set of processes 900 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 910 with information supplied by a designer, information which is transformed to create an article of manufacture that uses a set of EDA processes 912. When the design is finalized, the design is taped-out 934, which is when artwork (e.g., geometric patterns) for the integrated circuit is sent to a fabrication facility to manufacture the mask set, which is then used to manufacture the integrated circuit. After tape-out, a semiconductor die is fabricated 936 and packaging and assembly processes 938 are performed to produce the finished integrated circuit 940.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 9. The processes described by be enabled by EDA products (or EDA systems).

During system design 914, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 916, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 918, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 920, the netlist is checked for compliance with timing constraints and for correspondence with the HDL code. During design planning 922, an overall floor plan for the integrated circuit is constructed and analyzed for timing and top-level routing.

During layout or physical implementation 924, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 926, the circuit function is verified at the layout level, which permits refinement of the layout design. During physical verification 928, the layout design is checked to ensure that manufacturing constraints are correct, such as DRC constraints, electrical constraints, lithographic constraints, and that circuitry function matches the HDL design specification. During resolution enhancement 930, the geometry of the layout is transformed to improve how the circuit design is manufactured.

During tape-out, data is created to be used (after lithographic enhancements are applied if appropriate) for production of lithography masks. During mask data preparation 932, the ‘tape-out’ data is used to produce lithography masks that are used to produce finished integrated circuits.

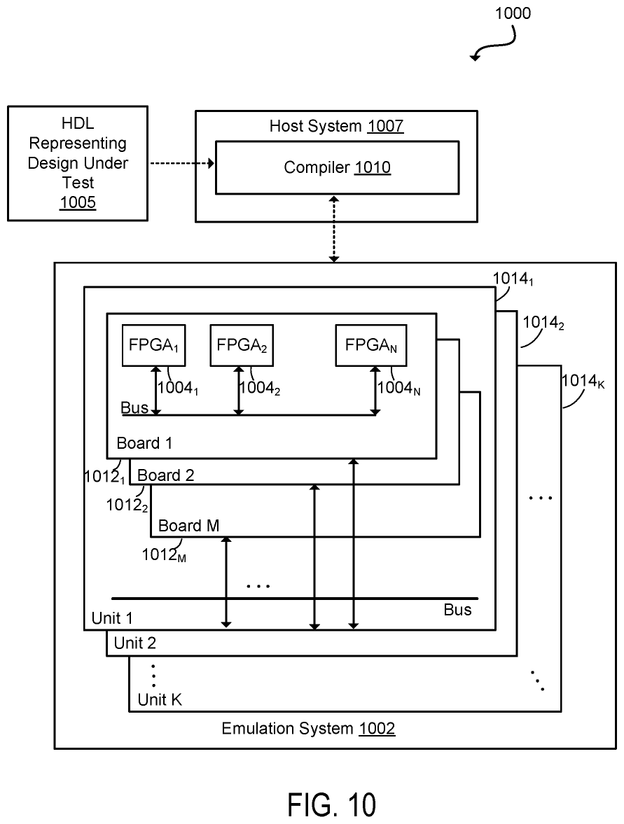

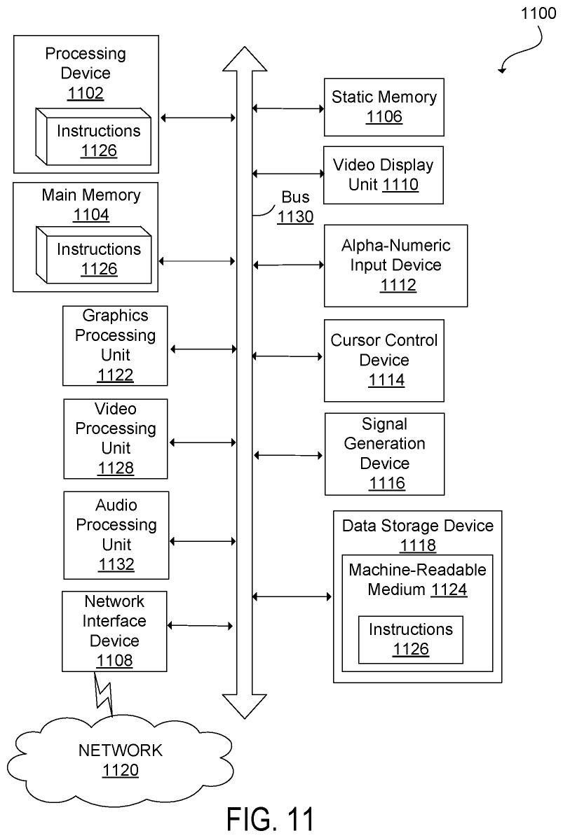

A storage subsystem of a computer system (such as computer system 1100 of FIG. 11, or host system 1007 of FIG. 10) may be used to store the programs and data structures that are used by some or all of the EDA products described herein, and products used for development of cells for the library and for physical and logical design that use the library.

FIG. 10 depicts a diagram of an example emulation environment 1000. An emulation environment 1000 may be configured to verify the functionality of the circuit design. The emulation environment 1000 may include a host system 1007 (e.g., a computer that is part of an EDA system) and an emulation system 1002 (e.g., a set of programmable devices such as Field Programmable Gate Arrays (FPGAs) or processors). The host system generates data and information by using a compiler 1010 to structure the emulation system to emulate a circuit design. A circuit design to be emulated is also referred to as a Design Under Test (‘DUT’) where data and information from the emulation are used to verify the functionality of the DUT.

The host system 1007 may include one or more processors. In the embodiment where the host system includes multiple processors, the functions described herein as being performed by the host system can be distributed among the multiple processors. The host system 1007 may include a compiler 1010 to transform specifications written in a description language that represents a DUT and to produce data (e.g., binary data) and information that is used to structure the emulation system 1002 to emulate the DUT. The compiler 1010 can transform, change, restructure, add new functions to, and/or control the timing of the DUT.

The host system 1007 and emulation system 1002 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 1002.11. The host system 1007 and emulation system 1002 can exchange data and information through a third device such as a network server.

The emulation system 1002 includes multiple FPGAs (or other modules) such as FPGAs 1004₁ and 1004₂ as well as additional FPGAs to 1004_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 1002 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 1004₁-804_{N} may be placed onto one or more boards 1012₁ and 1012₂ as well as additional boards through 1012_{M}. Multiple boards can be placed into an emulation unit 1014₁. The boards within an emulation unit can be connected using the backplane of the emulation unit or any other types of connections. In addition, multiple emulation units (e.g., 1014₁ and 1014₂ through 1014_{K}) can be connected to each other by cables or any other means to form a multi-emulation unit system.

For a DUT that is to be emulated, the host system 1007 transmits one or more bit files to the emulation system 1002. The bit files may specify a description of the DUT and may further specify partitions of the DUT created by the host system 1007 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 1007 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 1007 and/or the compiler 1010 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 1005 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 11 illustrates an example machine of a computer system 1100 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM), a static memory 1106 (e.g., flash memory, static random access memory (SRAM), etc.), and a data storage device 1118, which communicate with each other via a bus 1130.

Processing device 1102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 may be configured to execute instructions 1126 for performing the operations and steps described herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a non-transitory computer-readable medium) on which is stored one or more sets of instructions 1126 or software embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A non-transitory computer readable medium comprising stored instructions, which when executed by a processor, cause the processor to:
determine a first glitch-inducing-window (GIW) for a first combinational logic (CL) gate of a circuit design, subsequent to a modification of the circuit design that impacts the first CL gate, based on arrival time ranges of first and second inputs of the first CL gate; and
determine whether to retain the modification of the circuit design based on the first GIW.

2. The non-transitory computer readable medium of claim 1, wherein the stored instructions, when executed by the processor, further cause the processor to:
determine a width of the first GIW based on the arrival time range of the first input; and
determine a length of the first GIW based on the arrival time range of the second input.

3. The non-transitory computer readable medium of claim 2, wherein the stored instructions, when executed by the processor, further cause the processor to:
determine whether to retain the modification based on a position of the first GIW relative to a glitch band of the first CL gate, wherein a width of the glitch band represents internal delays of the first CL gate.

4. The non-transitory computer readable medium of claim 3, wherein the stored instructions, when executed by the processor, further cause the processor to:
determine a glitch factor based on an area of the first GIW that lies within the glitch band; and
determine whether to retain the modification of the circuit design based on the glitch factor.

5. The non-transitory computer readable medium of claim 4, wherein the stored instructions, when executed by the processor, further cause the processor to:
determine the glitch factor based on the area of the first GIW that lies within the glitch band and a total area of the first GIW.

6. The non-transitory computer readable medium of claim 1, wherein the stored instructions, when executed by the processor, further cause the processor to:
determine a second GIW for the CL gate prior to the modification of the circuit design; and
determine whether to retain the modification based on the first and second GIWs.

7. The non-transitory computer readable medium of claim 1, wherein the stored instructions, when executed by the processor, further cause the processor to:
compute a second GIW for a second CL gate impacted by the modification of the circuit design, wherein the second CL gate is within a fanout cone of the first CL gate; and
determine whether to retain the modification of the circuit design based further on the second GIW of the second CL gate.

8. The non-transitory computer readable medium of claim 1, wherein the stored instructions, when executed by the processor, further cause the processor to:
determine a parameter and a glitch metric of the circuit design prior to the modification to the circuit design, wherein the parameter comprises one or more of a timing parameter, a power consumption parameter, and an area parameter, and wherein the glitch metric comprises one or more of glitch toggles associated with the first CL gate and glitch power associated with the glitch toggles;
update the parameter and the glitch metric subsequent to the modification to the circuit design; and
determine whether to retain the modification to the circuit design based further on the updated parameter and the updated glitch metric.

9. A method, comprising:
determining a first glitch factor for a first combinational logic (CL) gate of a circuit design based on arrival time ranges at first and second inputs of the first CL gate and an internal delay of the first CL gate;
performing a first incremental modification to the circuit design, wherein the first incremental modification impacts the first CL gate;
updating the first glitch factor for the first CL gate subsequent to the first incremental modification; and
determining whether to retain the first incremental modification of the circuit design based on the updated first glitch factor for the first CL gate and an optimization criterion.

10. The method of claim 9, wherein determining the first glitch factor comprises:
determining a first glitch inducing window (GIW) for the first CL gate based on the arrival time ranges at the first and second inputs to the first CL gate;
determining a glitch band of the first CL gate based on the internal delay of the first CL gate; and
determining the first glitch factor based on an area of the first GIW that lies within the glitch band.

11. The method of claim 10, wherein determining the first GIW comprises:
determining a width of the first GIW based on the arrival time range at the first input to the first CL gate; and
determining a length of the first GIW based on the arrival time range at the second input to the first CL gate.

12. The method of claim 9, wherein performing the first incremental modification comprises replacing the first CL gate with a replacement CL gate, and wherein updating the first glitch factor comprises:
determining a second GIW of the replacement CL gate based on arrival time ranges at first and second inputs to the replacement CL gate;
determining a glitch band of the replacement CL gate based on the internal delay of the replacement CL gate; and
updating the first glitch factor based on an area of the second GIW of the replacement CL that lies within the glitch band of the replacement CL.

13. The method of claim 9, further comprising:
determining a parameter and a glitch metric of the circuit design prior to the performing the first incremental modification, wherein the parameter comprises one or more of a timing parameter, a power consumption parameter, and an area parameter, and wherein the glitch metric comprises one or more of glitch toggles associated with the first CL gate and glitch power associated with the glitch toggles;
updating the parameter and the glitch metric subsequent to performing the first incremental modification; and
determining whether to retain the first incremental modification based further on the updated parameter and the updated glitch metric.

14. The method of claim 13, wherein determining the parameter and the glitch metric of the circuit design prior to performing the first incremental modification comprises one or more of:
simulating operation of the circuit design;
emulating the operation of the circuit design; and
prototyping the operation of the circuit design.

15. The method of claim 13, further comprising:
performing a second incremental modification to the circuit design, wherein the second incremental modification impacts the first CL gate;
updating the parameter and the glitch metric subsequent to the second incremental modification; and
determining whether to retain the second incremental modification based on the corresponding updated parameter, updated glitch metric, and updated glitch factor, and the optimization criterion.

16. The method of claim 9, further comprising:
determining a second glitch factor for a second CL gate within a fanout cone of the first CL gate, prior to the first incremental modification, based on arrival time ranges of first and second inputs of the second CL gate and an internal delay of the second CL gate;
updating the second glitch factor for the second CL gate subsequent to the first incremental modification; and
determining whether to retain the first incremental modification to the circuit design based further on the updated second glitch factor for the second CL gate.

17. A system comprising:
a memory storing instructions; and
a processor, coupled with the memory and to execute the instructions, the instructions when executed cause the processor to,
determine a glitch factor for a combinational logic (CL) gate of a circuit based on arrival time ranges at first and second inputs of the CL gate and an internal delay of the CL gate;
update the glitch factor for the CL gate subsequent to a modification to the circuit design that impacts the CL gate; and
determine whether to retain the incremental modification to the circuit design based on the updated glitch factor for the CL gate and an optimization criterion.

18. The system of claim 17, wherein the instructions when executed, further cause the processor to:
determine a glitch inducing window (GIW) for the CL gate based on the arrival time ranges at the first and second inputs to the CL gate;
determine a glitch band of the CL gate based on the internal delay of the CL gate; and
determine the glitch factor based on an area of the GIW that lies within the glitch band.

19. The system of claim 18, wherein the instructions when executed, further cause the processor to:
determine a width of the GIW based on the arrival time range at the first input to the CL gate; and
determine a length of the GIW based on the arrival time range at the second input to the CL gate.

20. The system of claim 18, wherein the modification to the circuit design replaces the CL gate with a replacement CL gate, and wherein the instructions when executed, further cause the processor to update the glitch factor by:
determining a GIW of the replacement CL gate based on arrival time ranges at first and second inputs to the replacement CL gate;
determining a glitch band of the replacement CL gate based on the internal delay of the replacement CL gate; and
updating the glitch factor based on an area of the GIW of the replacement CL that lies within the glitch band of the replacement CL.
